(19) United States
(12) Patent Application Publication
(10) Pub. No.: US 2026/0073505 A1
(43) Pub. Date: Mar. 12, 2026

(54) THREE-DIMENSIONAL IMAGE GENERATION METHOD AND ELECTRONIC DEVICE FOR PERFORMING SAME

(71) Applicant: SG HEALTHCARE CO., LTD, Icheon-si (KR)

(72) Inventors: Eungbum KIM, Hwaseong-si (KR); Jae Hyun LIM, Yongin-si (KR); Jung Soo KIM, Seoul (KR)

(73) Assignee: SG HEALTHCARE CO., LTD, Icheon-si (KR)

(21) Appl. No.: 18/876,593

(22) PCT Filed: Jul. 5, 2023
(86) PCT No.: PCT/KR2023/009501

§ 371 Date: Dec. 18, 2024

(30) Foreign Application Priority Data
Jul. 8, 2022 (KR) 10-2022-0084390
Jul. 3, 2023 (KR) 10-2023-0085670

(51) Int. Cl. G06T 7/00; G06T 7/20; G06T 7/55; G06T 7/73; G06T 11/00

(52) U.S. Cl. CPC G06T 7/001; G06T 7/20; G06T 7/55; G06T 7/74; G06T 12/20; G06T 12/30; G06T 2207/10081; G06T 2207/10112; G06T 2207/10121; G06T 2207/30108; G06T 2211/441

(57) ABSTRACT

Disclosed are a three-dimensional image generation method and an electronic device for performing same, according to various embodiments. The electronic device according to one embodiment of the present invention comprises: an image capture device for acquiring a plurality of radiological images for a sample moving on a transport device; and a processor, wherein the processor can: determine feature points of the plurality of radiological images, for reconstructing a three-dimensional image of the sample; use the location of the feature points to calculate the location information of the feature points; generate a feature point image on the basis of the location information; and generate the three-dimensional image by using the feature point image and the location information.

### TECHNICAL FIELD

The following description relates to a three-dimensional (3D) image generation method and an electronic device performing the 3D image generation method. The following description relates, more particularly, to a 3D image generation method and an electronic device that may perform inspection using radiation on a conveyor belt or in-line, without moving a sample or specimen to a separate chamber or the like.

### BACKGROUND ART

In the field of industrial radiation inspection equipment, to three-dimensionally inspect the interior of an object, a method of moving a sample or specimen that is on the move through a transport device such as a conveyor belt to a space equipped with separate inspection equipment for inspection and then moving them back to the transport device such as the conveyor belt has been used.

This method of moving the sample from the conveyor belt to the inspection equipment may, however, make it difficult to perform total inspection on products due to the travel time of the sample and the waiting time before the sample enters the inspection equipment, and therefore a method of limiting the number of samples of certain types or ranges and inspecting them has been mainly used.

Although defects may be found randomly in industrial products, high-speed precise inspection may be performed to screen these random defects out in advance and prevent potential fires and accidents that may be caused by such defective products. In the case of batteries and engines for vehicles, in particular, total inspection of parts is required because accidents may lead to human casualties. However, due to the time used for the inspection, selective inspection is performed only on some products.

In the case of two-dimensional (2D) fluoroscopic inspection performed to inspect products for defects at high speed, identifying defects may not be easy due to distortion caused by a difference in the light path of X-rays and overlapping images of objects.

To solve such distortion and overlap that may occur in the 2D fluoroscopic inspection, a method of inspecting products using computed tomography (CT) is used. However, this method may require a great amount of time for capturing images, making it difficult to perform total inspection.

### DISCLOSURE OF THE INVENTION

### Technical Goals

Industrial inspection equipment requires a pass/fail determination technique based on high speed and accurate images, but capturing only one or two images in exchange for high speed may not be sufficient to acquire images accurate enough for pass/fail determination. Also, capturing multiple images in exchange for the acquisition of accurate images may require a great amount of time to reconstruct the images for analysis due to the capacity of the images.

Various embodiments may provide a three-dimensional (3D) image generation method and an electronic device that may reconstruct an accurate 3D image of an object to be inspected and modify a tomosynthesis or spiral computed tomography (CT) to reduce the inspection time, thereby applying them to industrial inspection equipment.

Various embodiments may provide a 3D image generation method and an electronic device that may reconstruct a 3D image of a sample to be inspected, only with a small amount of image data, while the sample is moving on a conveyor belt of a transport device, to increase the speed of image capturing and inspection.

Various embodiments may provide a 3D image generation method and an electronic device that may apply a 3D fluoroscopic imaging technique suitable for an industrial environment to reduce the inspection time for a sample and reduce the size of data required for 3D image reconstruction.

### Technical Solutions

According to various embodiments, an electronic device may include: an image capture device configured to acquire a plurality of radiological images of a sample moving in a set direction on a transport device; and a processor, wherein the processor may be configured to: determine a feature point of the plurality of radiological images for reconstructing a three-dimensional (3D) image of the sample; calculate position information of the feature point, using a position of the feature point; generate a feature point image based on the position information; and generate the 3D image using the feature point image and the position information.

The image capture device may include a radiation irradiation device and a detector having two-dimensionally arranged pixels, and may be configured to acquire the plurality of radiological images when the sample passes through a cone beam region determined according to the radiation irradiation device and the detector.

The radiation irradiation device may be configured to emit radiation in the form of a pulse to the sample.

The detector may include a gate line and an output line for transmitting a signal detected on a panel of the detector, wherein the processor may be configured to control a frame from which the plurality of radiological images is acquired by driving the gate line in an effective region corresponding to a region in which the sample moves on the transport device, and the gate line may be disposed in a direction parallel to the set direction in which the sample moves.

The processor may be configured to determine whether the sample is defective by comparing the 3D image to a set reference.

The image capture device may be configured to acquire a plurality of radiological images of a plurality of samples, and the processor may be configured to determine the feature point using the plurality of radiological images of the plurality of samples.

The processor may be configured to: preprocess the plurality of radiological images; and determine the feature point using the preprocessed plurality of radiological images.

The processor may be configured to determine whether a foreign object has been introduced into the sample by comparing a pixel value of the plurality of radiological images to a set threshold value.

According to various embodiments, an electronic device may include: an image capture device configured to acquire a plurality of radiological images of a sample moving in a set direction on a transport device; and a processor, wherein the processor may be configured to: determine a feature point of the plurality of radiological images, based on at least one of a shape of the sample and a feature of the plurality of radiological images; calculate position information of the sample corresponding to the feature point, using a position of the feature point and a speed of the transport device; and generate a 3D image of the sample by matching the plurality of radiological images, based on the position information.

The image capture device may include a radiation irradiation device and a detector having two-dimensionally arranged pixels, and may be configured to acquire the plurality of images when the sample passes through a cone beam region determined according to the radiation irradiation device and the detector.

The processor may be configured to determine whether the sample is defective by comparing the 3D image to a set reference.

According to various embodiments, a 3D image generation method may include: acquiring, using an image capture device, a plurality of radiological images of a sample moving in a set direction on a transport device; determining a feature point of the plurality of radiological images for reconstructing a 3D image of the sample; calculating position information of the feature point using a position of the feature point; generating a feature point image based on the position information; and generating the 3D image, using the feature point image and the position information.

The image capture device may include a radiation irradiation device and a detector having two-dimensionally arranged pixels, wherein the acquiring of the plurality of radiological images may include acquiring the plurality of radiological images when the sample passes through a cone beam region determined according to the radiation irradiation device and the detector.

The acquiring of the plurality of radiological images may include emitting radiation in the form of a pulse to the sample, using the radiation irradiation device.

The detector may include a gate line and an output line for transmitting a signal detected on a panel of the detector, wherein the acquiring of the plurality of radiological images may include: controlling a frame from which the plurality of radiological images is acquired, by driving the gate line in an effective region corresponding to a region in which the sample moves on the transport device, and the gate line may be disposed in a direction parallel to the set direction in which the sample moves.

The 3D image generation method may further include determining whether the sample is defective by comparing the 3D image to a set reference.

The acquiring of the plurality of radiological images may include acquiring a plurality of radiological images of a plurality of samples, wherein the determining of the feature point may include determining the feature point, using the plurality of radiological images of the plurality of samples.

The 3D image generation method may further include preprocessing the plurality of radiological images, wherein the determining of the feature point may include determining the feature point, using the preprocessed plurality of radiological images.

The 3D image generation method may further include determining whether a foreign object has been introduced into the sample by comparing a pixel value of the plurality of radiological images to a set threshold value.

### Effects of Invention

A three-dimensional (3D) image generation method and an electronic device of various embodiments described herein may generate a 3D image of a sample on a conveyor belt or in-line and perform inspection on the sample, without moving the sample requiring 3D inspection to a separate chamber or space.

A 3D image generation method and an electronic device of various embodiments described herein may reduce and/or improve the inspection time for a sample, simplify processing steps for the sample, and reduce the size of data for a 3D image of the sample.

A 3D image generation method and an electronic device of various embodiments described herein may generate an accurate 3D image of an object to be inspected to increase the inspection accuracy and reduce the inspection speed.

### BRIEF DESCRIPTION OF DRAWINGS

FIG. 1 is a schematic block diagram illustrating an electronic device according to various embodiments.

FIG. 2 is a diagram illustrating an operation performed by an electronic device to acquire a radiological image of a sample according to various embodiments.

FIG. 3 is a flowchart illustrating a three-dimension (3D) image generation method according to various embodiments.

FIG. 4 is a diagram illustrating an operation performed by an electronic device to determine feature points using a plurality of radiological images according to various embodiments.

FIG. 5 is a diagram illustrating an image signal detected by a detector as a sample moves.

FIG. 6 is a diagram illustrating an output of radiation emitted from a radiation irradiation device according to various embodiments.

FIG. 7 is a diagram illustrating an operational frame of a detector according to various embodiments.

FIG. 8 is a diagram illustrating a gate line and an output line of a detector according to various embodiments.

FIG. 9 is a two-dimensional (2D) image acquired by an electronic device according to various embodiments.

FIG. 10 is a cross-section of a 3D image generated by an electronic device according to various embodiments.

### BEST MODE FOR CARRYING OUT THE INVENTION

Hereinafter, embodiments will be described in detail with reference to the accompanying drawings. However, various changes or modifications may be made to the embodiments. Here, the embodiments are not construed as limiting the disclosure and should be understood to include all changes, equivalents, and replacements within the idea and the technical scope of the disclosure.

The terminology used herein is for describing various examples only and is not to be used to limit the disclosure. The articles “a,” “an,” and “the” are intended to include the plural forms as well, unless the context clearly indicates otherwise. As used herein, the terms “comprise” or “comprises,” “include” or “includes,” and “have” or “has” specify the presence of stated features, numbers, steps, operations, members, elements, and/or combinations thereof, but do not preclude the presence or addition of one or more other features, numbers, steps, operations, members, elements, and/or combinations thereof.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

In addition, when describing the embodiments with reference to the accompanying drawings, like reference numerals refer to like components, and a repeated description related thereto is omitted. In describing the embodiments, where it is determined that a detailed description of the related art would unnecessarily obscure the essence of the embodiments, such detailed description is omitted.

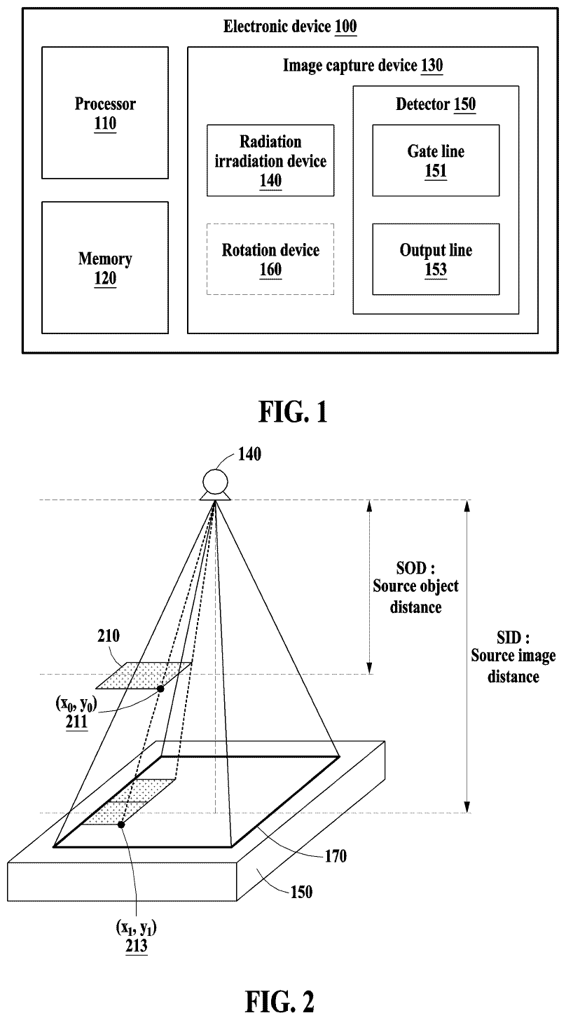

FIG. 1 is a schematic block diagram illustrating an electronic device 100 according to various embodiments.

Referring to FIG. 1, the electronic device 100 of various embodiments may include a processor 110, a memory 120, and an image capture device 130.

For example, the processor 110 may execute software (e.g., a program) to control at least one component (e.g., a hardware or software component) of the electronic device 100 connected to the processor 110, and may perform various data processing or computations. In one embodiment, as at least part of the data processing or computations, the processor 110 may store instructions or data received from another component (e.g., a sensor, the image capture device 130, etc.) in a volatile memory, process the instructions or data stored in the volatile memory, and store resulting data in a non-volatile memory.

In one embodiment, the processor 110 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor. For example, when the electronic device 100 includes the main processor and the auxiliary processor, the auxiliary processor may be adapted to consume less power than the main processor or to be specific to a specified function. The auxiliary processor may be implemented separately from the main processor or as part of the main processor.

The auxiliary processor may control at least some of functions or states related to at least one (e.g., a display module, a sensor module, or a communication module) of the components of the electronic device 100, instead of the main processor while the main processor is in an inactive (e.g., sleep) state or along with the main processor while the main processor is an active state (e.g., executing an application). In one embodiment, the auxiliary processor (e.g., an ISP or a CP) may be implemented as a portion of another component (e.g., a camera module or a communication module) that is functionally related to the auxiliary processor. In one embodiment, the auxiliary processor (e.g., an NPU) may include a hardware structure specifically for artificial intelligence (AI) model processing. An AI model may be generated by machine learning. The learning may be performed by, for example, the electronic device 100 in which the AI model is performed or performed via a separate server. Learning algorithms may include, but are not limited to, for example, supervised learning, unsupervised learning, semi-supervised learning, or reinforcement learning. The AI model may include a plurality of artificial neural network (ANN) layers. An ANN may include, but is not limited to, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof. The AI model may alternatively or additionally include a software structure other than the hardware structure.

The memory 120 may store various pieces of data used by at least one component (e.g., the processor 110 or the sensor module) of the electronic device 100. The various pieces of data may include, for example, software (e.g., a program) and input data or output data for commands related thereto. The memory 120 may include a volatile memory or a non-volatile memory.

The image capture device 130 may include a radiation irradiation device 140 (e.g., an X-ray tube), a detector 150, and a rotation device 160. The detector 150 may include a gate line 151, an output line 153, and a panel.

The image capture device 130 may acquire a plurality of radiological images of a sample (or specimen) moving on a transport device. For example, the image capture device 130 may detect, by the detector 150, radiation emitted from the radiation irradiation device 140 to acquire the plurality of radiological images of the sample. In this case, there is a difference in the intensity between radiation that passes through the sample and is detected and radiation that does not pass through the sample. The electronic device 100 may acquire a radiological image of the sample based on a signal (e.g., a detected radiation signal and image signal) detected by the detector 150.

For example, the radiation irradiation device 140 may be disposed above the transport device that moves the sample in a straight line, and the detector 150 may be disposed below the transport device. While the sample is moving in a straight line on the transport device, as the radiation irradiation device 140 emits radiation and the detector 150 detects the radiation, the image capture device 130 may thereby acquire the plurality of radiological images of the sample. The transport device may include a conveyor belt with high radiation transmittance.

The sample may be moved through the transport device disposed between the radiation irradiation device 140 and the detector 150, in a straight-line direction perpendicular to a normal line of a focal point of the tube and the detector 150 (e.g., an x-ray detector).

For example, the detector 150 may include the panel with two-dimensionally arranged pixels. The image capture device 130 may acquire a two-dimensional (2D) radiological image of the sample based on the magnitude of a radiation signal detected on the panel.

The plurality of radiological images acquired by the image capture device 130 may be acquired for the sample that is moving, and a position of the sample may vary when each radiological image is acquired. Therefore, when each of the plurality of radiological images is acquired, the angle, position, distance, or the like associated with emitting radiation to the sample may vary.

The electronic device 100 may determine feature points of the plurality of radiological images to reconstruct a three-dimensional (3D) image of the sample. For example, a feature point may represent a reference point for combining the plurality of radiological images. In one embodiment, the electronic device 100 may determine the feature points using a pattern that is set based on the shape of the sample. In another embodiment, the electronic device 100 may determine the feature points based on features of the radiological images.

Based on a position of a feature point, the electronic device 100 may calculate position information of the feature point. The position information of the feature point may include an angle of the feature point, coordinates of the feature point, or the like.

Based on the position information, the electronic device 100 may generate a feature point image. The electronic device 100 may generate a 2D feature point image by matching or aligning the feature points of the plurality of radiological images. The electronic device 100 may generate the feature point image by matching the position information of the feature points of the plurality of radiological images.

As the sample moves in the transport device, the position information of the feature points in the radiological images may differ. Based on the position information of the feature points, the electronic device 100 may reposition the radiological images such that the feature points of the respective radiological images may be matched according to the position information of the feature points, and may combine the repositioned radiological images to generate the feature point image.

For example, the electronic device 100 may match the feature point image to a position of the sample (on the transport device). The electronic device 100 may generate a plurality of feature point images of the sample, using the plurality of radiological images captured while the sample is passing through a cone beam region.

The electronic device 100 may preprocess the plurality of radiological images and generate the feature point image using the preprocessed plurality of radiological images. The electronic device 100 may reduce the size of the radiological images such that the radiological images include a region from which the sample is captured. The electronic device 100 may identify a region from which the sample is captured and a region from which the sample is not captured from the radiological images.

The electronic device 100 may preprocess the plurality of radiological images based on the feature points. For example, it may reduce the size of a radiological image such that the radiological image includes a region set based on a feature point.

The electronic device 100 may generate the 3D image of the sample using the feature point image and the position information. The electronic device 100 may generate the 3D image of the sample by matching the position information of the feature points in the respective feature point images.

To reconstruct the 3D image of the sample, coordinate information of each of the radiation irradiation device 140, the detector 150, and the sample, and a radiological image according to the coordinate information may be required. For coordinates of the radiation irradiation device 140 and the detector 150, set coordinates may be used. As will be described with reference to FIG. 2, the electronic device 100 may calculate position information (e.g., coordinates of the sample) of a feature point of the sample using the position information of the feature points of the radiological images.

For example, the electronic device 100 may generate the 3D image from the plurality of feature point images using tomosynthesis. Tomosynthesis refers to an image generation technique that captures an image of a portion to be observed and synthesizes the captured images, which may include recombining a plurality of 2D images or images captured in a certain angle range (e.g., approximately 15 degrees (°) to 50°) and synthesizing a plurality of slice images.

Because the plurality of radiological images is acquired for the sample on the move, the electronic device 100 may acquire radiological images with different angles between the sample and the radiation irradiation device 140. In addition, because the feature point image is generated using the plurality of radiological images, the angle between the sample and the radiation irradiation device 140 may differ in each feature point image. The electronic device 100 may synthesize the feature point images of different angles with respect to the sample to generate the 3D image of the sample.

In addition to the method described above, the electronic device 100 may generate the 3D image of the sample using various techniques for generating a 3D image of an object, using images captured at different angles with respect to the object.

For example, the image capture device 130 may include the rotation device 160. The rotation device 160 may allow the radiation irradiation device 140 and the detector 150 to rotate relative to the transport device. As the radiation irradiation device 140 and the detector 150 rotate when the sample moves on the transport device, the image capture device 130 may acquire a plurality of radiological images of the sample from various angles.

The electronic device 100 may generate the 3D image of the sample using the plurality of radiological images acquired using the radiation irradiation device 140 and the detector 150 that rotate. The electronic device 100 may generate the feature point image using the plurality of radiological images acquired using the image capture device 130 including the rotation device 160. The electronic device 100 may generate the 3D image of the sample using the feature point image and the position information.

The electronic device 100 may use various methods, such as, for example, a spiral computed tomography (CT) scan method, to acquire a 3D image of an object to be inspected by synthesizing a plurality of images acquired using the image capture device 130 that rotates relative to the object. The spiral CT scan method may refer to an image generation method that captures an image while passing between the radiation irradiation device 140 (e.g., an X-ray tube) and the detector 150 that rotate around a certain portion of an object to be inspected and then reconstructs a specified portion to be reconstructed into a 3D image.

The electronic device 100 may determine whether the sample is defective by comparing the 3D image to a set reference. For example, the electronic device 100 may determine whether the sample is defective by comparing various 3D shape features, such as, the geometry, size, shape, or the like of the 3D image to the set reference.

However, examples are not limited thereto, and the electronic device 100 may extract or calculate various information about the sample from the 3D image to determine whether the sample is defective, and the reference used to determine whether the sample is defective may be set in various ways.

The electronic device 100 may reconstruct or generate the 3D image of the sample by accumulating values acquired by projecting, onto voxels generated in a 3D virtual space, various angle images of the sample through which radiation (e.g., X-ray) has been transmitted.

To perform computations required to generate the 3D image of the sample, the electronic device 100 may transmit a 2D transmission image (e.g., a plurality of radiological images, a feature point image, etc.) to the memory 120 or the processor 110 (e.g., a GPU) for image processing, and perform a computation for constructing the 3D virtual space. The electronic device 100 may project each angle image onto a voxel in the 3D virtual space and store the 3D image of the sample.

To reduce a time used for a computational step for generating the 3D image of the sample, the electronic device 100 may preprocess the plurality of radiological images and generate the feature point image using the preprocessed plurality of radiological images, as described above.

Further, as will be described below, the electronic device 100 may reduce the time used for the computational step by acquiring a plurality of radiological images of a plurality of samples and performing computations for generating a 3D image of the plurality of samples in parallel.

The image capture device 130 may acquire a plurality of radiological images of a plurality of samples. Using the plurality of radiological images of the plurality of samples, the electronic device 100 may determine feature points of the plurality of radiological images. The feature points of the plurality of radiological images may be determined for each of the plurality of samples.

Using the feature points of the plurality of radiological images of the plurality of samples, the electronic device 100 may generate a 3D image of each of the plurality of samples. The operations of the electronic device 100 to generate the 3D image for each of the plurality of samples may be substantially the same as the operations of the electronic device 100 to generate a 3D image for a single sample.

By acquiring the plurality of radiological images of the plurality of samples and generating the 3D image of each of the plurality of samples, the electronic device 100 may reduce or improve the time used to generate 3D images of all the samples. Further, by generating the 3D image of each of the plurality of samples, the electronic device 100 may reduce the inspection time required to determine whether all the samples are defective.

The electronic device 100 may also reduce the time used for computations by acquiring a 2D radiological image corresponding to a partial region of the detector 150 or by using some of the plurality of radiological images to reduce the number of radiological images to be processed.

Using the plurality of radiological images, the electronic device 100 may determine whether a foreign object has been introduced into the sample. For example, the electronic device 100 may determine whether a foreign object has been introduced into the sample, using a pixel value of a radiological image or a pixel value of a set region.

The electronic device 100 may determine whether a foreign object has been introduced into the sample by comparing a pixel value of a radiological image to a set pixel value. For example, in response to a difference between the pixel value of the radiological image and the set pixel value exceeding a set range, the electronic device 100 may determine that a foreign object has been introduced into the sample.

The electronic device 100 may determine whether a foreign object has been introduced, using a pixel value of a radiological image or a standard deviation of pixel values of a partial region. The partial region or set region of a radiological image may be determined based on a set reference (or criterion).

For example, the electronic device 100 may identify a region in a radiological image from which the sample is captured. The electronic device 100 may calculate a standard deviation of all or some of pixel values of the region where the sample is captured. The electronic device 100 may determine whether a foreign object has been introduced, based on settings (e.g., if the calculated standard deviation is less than a set standard deviation, if the calculated standard deviation is greater than the set standard deviation, if the calculated standard deviation exceeds a set standard deviation range, etc.).

In this case, when a foreign object has been introduced into the sample, the amount of radiation transmittance changes due to the foreign object, and thus the electronic device 100 may determine whether a foreign object has been introduced into the sample by using a pixel value of a radiological image or a pixel value of a partial region of the radiological image.

FIG. 2 is a diagram illustrating an operation performed by the electronic device 100 to acquire a radiological image of a sample 210 according to various embodiments.

As shown in FIG. 2, the radiation irradiation device 140 may be disposed above the sample 210 moving on a transport device, and the detector 150 may be disposed below the sample 210.

The sample 210 may move in a set direction on the transport device. For example, as shown in FIG. 2, the sample 210 may be moved by the transport device from left (e.g., a 9 o'clock direction in FIG. 2) to right (e.g., a 3 o'clock in FIG. 2).

The image capture device 130 may acquire a plurality of radiological images of the sample 210 moving in the set direction on the transport device. As the image capture device 130 acquires the plurality of radiological images of the sample 210 moving in the set direction by the transport device, the electronic device 100 may determine whether the sample 210 is defective without moving the sample 210 to a separate space or stopping the sample 210. By acquiring the plurality of radiological images as the sample 210 is moving according to a typical process, the electronic device 100 may reduce the inspection time for the sample 210.

A cone beam region 170 from which a radiological image of the sample 210 is captured may be determined depending on positions of the radiation irradiation device 140 and the detector 150. The image capture device 130 may acquire a radiological image of the sample 210 as the sample 210 passes through the cone beam region 170. The transport device may be disposed to allow the sample 210 to pass through the cone beam region 170. For example, as shown in FIG. 2, the transport device may be disposed such that the sample 210 passes through the cone beam region 170 while moving from left (e.g., the 9 o'clock direction in FIG. 2) to right (e.g., the 3 o'clock direction in FIG. 2).

FIG. 2 illustrates an operation performed by the image capture device 130 to acquire a radiological image when a portion of the sample 210 is located in the cone beam region 170. The operation performed by the image capture device 130 to acquire a radiological image may be substantially the same as one performed when the entirety of the sample 210 is located in the cone beam region 170.

The arrangement of the radiation irradiation device 140 and the detector 150 shown in FIG. 2 is provided as an example, and examples of the arrangement are not limited to what is shown in FIG. 2.

The electronic device 100 may determine a feature point 213 of a radiological image, as shown in FIG. 2. For example, the electronic device 100 may determine the feature point 213 of the radiological image based on the shape of the sample 210. In a case where the shape of the sample 210 is a rectangular plate as shown in FIG. 2, the electronic device 100 may determine a vertex of a rectangular radiological image to be the feature point 213.

For example, the electronic device 100 may determine the feature point 213 of the radiological image based on a feature of the radiological image. In a case where the radiological image is a rectangle as shown in FIG. 2, the electronic device 100 may determine a vertex of the rectangle to be the feature point 213.

The electronic device 100 may recognize a pattern of radiological images. The electronic device 100 may use the shape of the sample 210 or a marker to determine, to be a start point of the radiological images of the sample 210, a radiological image from which the pattern is recognized. The electronic device 100 may determine the feature point 213 of the radiological image based on the recognized pattern of the radiological images.

The electronic device 100 may determine, to be an end point of the radiological images of the sample 210, a radiological image from which a set pattern is not recognized or a radiological image captured in a frame immediately preceding the radiological image from which the set pattern is not recognized.

The electronic device 100 may use a pixel value of a radiological image to determine the start point and/or end point of the radiological images of the sample 210. For example, in a case where a pixel value of a set region in a radiological image is changed from a set value (e.g., an initial value), the electronic device 100 may determine that the sample 210 has reached the cone beam region 170. When the sample 210 has reached the cone beam region 170, the electronic device 100 may determine the corresponding radiological image to be the start point.

The electronic device 100 may use a pixel value of a radiological image to determine the end point of the radiological images. For example, in a case where a pixel value in a set region of a radiological image is changed from a set value (e.g., an initial value) and then returns to the initial value, the electronic device 100 may determine that the sample 210 is out of the cone beam region 170. When the sample 210 is out of the cone beam region 170, the electronic device 100 may determine, to be the end point, a corresponding frame or a radiological image captured in a frame immediately preceding the frame.

In a case of capturing a plurality of radiological images of a plurality of samples 210, the electronic device 100 may determine a start point and/or end point of the radiological images for each of the plurality of samples 210.

Using a position of the feature point 213 of the radiological image, the electronic device 100 may calculate position information of the feature point 213 of the radiological image and/or position information of a feature point 211 of the sample 210. The position information of the feature point 213 of the radiological image may include coordinates of the feature point 213, an angle, a magnification, or the like of the radiological image. The position information of the feature point 211 of the sample 210 may include coordinates of the feature point 211, an angle, a magnification, or the like of the sample 210.

For example, as shown in FIG. 2, in a case where a position the feature point 213 of the radiological image is (x₁, y₁), the electronic device 100 may determine the position information of the feature point 213 of the radiological image and/or the position information of the feature point 211 of the sample 210, as expressed in Equations 1 to 4 below. A focal point on a plane of the detector 150 may refer to a point at which a line extending perpendicularly to the plane of the detector 150 from a position of the radiation irradiation device 140 meets. A position of a feature point of a radiological image may be determined using the focal point on the plane of the detector 150 as the origin.

$$θ = {tan}^{- 1} \frac{\sqrt{{x}_{1}^{2} + {y}_{1}^{2}}}{{SID}^{2}} \qquad [ Equation 1 ]$$

In Equation 1 above, θ may denote an angle of a feature point. The angle θ of the feature point may represent an angle formed among the feature point 213 of the radiological image, the radiation irradiation device 140, and the focal point. In Equation 1, SID, or a source image distance, may denote a distance from the radiation irradiation device 140 to the focal point on the plane of the detector 150.

$$M = \frac{SID}{SOD} \qquad [ Equation 2 ]$$

In Equation 2 above, M may denote a magnification factor, and SOD, or a source object distance, may denote a distance from the radiation irradiation device 140 to a focal point on an object plane. The focal point of the object plane may be determined substantially the same as the focal point on the plane of the detector 150. The focal point of the object plane may refer to a point at which a line extending perpendicularly to the object plane from the position of the radiation irradiation device 140 meets. As shown in FIG. 2, a position (x₀, y₀) of the feature point 211 of the sample 210 may be determined using the focal point of the object plane as the origin.

$${x}_{0} = \frac{{x}_{1}}{M} \qquad [ Equation 3 ]$$

$${y}_{0} = \frac{{y}_{1}}{M} \qquad [ Equation 4 ]$$

The electronic device 100 may determine the position (x₀, y₀) of the feature point 211 of the sample 210, as expressed in Equations 3 and 4 above. An angle of the feature point 211 of the sample 210 may be the same as the angle of the feature point 213 of the radiological image.

Although an example where the electronic device 100 calculates position information (e.g., an angle, a magnification, a position of a feature point of the sample 210, etc.) of a feature point of a radiological image using the position (x₁, y₁) of the feature point 213 of the radiological image is described herein with respect to Equations 1 to 4 above, examples are not limited thereto. For example, the electronic device 100 may calculate position information of a feature point of the sample 210 after “t” seconds, using the position (x₀, y₀), time, and movement velocity of the feature point 213 of the sample 210.

For example, in a case where the position of the feature point 211 of the sample 210 at a time 0s is (x₀, y₀), a position of a feature point of the sample 210 at a time t may be (x₀+vt, y₀+vt), where v denotes a velocity (of movement) of the sample 210 by the transport device. The electronic device 100 may calculate the position information of the feature point of the sample 210 after t seconds, using the velocity of the sample 210 and a frame in which a radiological image is captured.

A characteristic of an operation of calculating the position information of the feature point of the sample 210 after t seconds based on the movement velocity may be similarly applied to an operation of calculating position information of a feature point of a radiological image after t seconds based on the movement velocity. To calculate the position information of the feature point of the radiological image after t seconds, the movement velocity and the magnification may be considered.

For example, in a case where the sample 210 moves from left (e.g., the 9 o'clock direction in FIG. 2) to right (e.g., the 3 o'clock direction in FIG. 2) on the transport device, the electronic device 100 may acquire a plurality of radiological images corresponding to different positions of the sample 210. In this case, positions, angles, or the like of feature points of the radiological images may be different.

For example, the electronic device 100 may use a time at which the sample 210 enters the cone beam region 170 to determine the position information of the sample 210 at a point in time when each of the plurality of radiological images is captured. The electronic device 100 may include a sensor for sensing whether the sample 210 has entered the cone beam region 170. The electronic device 100 may calculate the position information of the sample 210 based on the time at which the sensor indicates that the sample 210 has entered the cone beam region 170, in consideration of a velocity at which the transport device moves the sample 210. The electronic device 100 may match the calculated position information of the sample 210 to each radiological image.

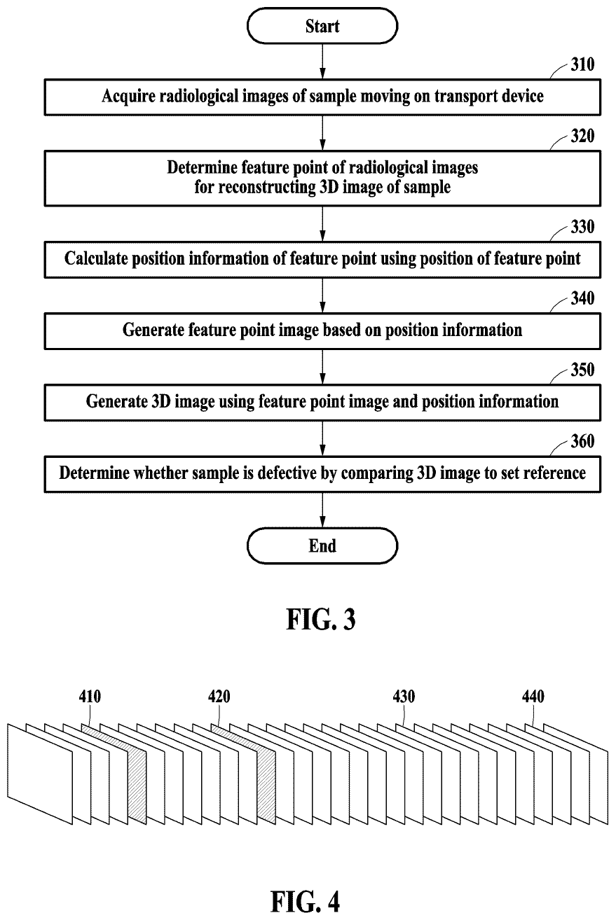

FIG. 3 is a flowchart illustrating a 3D image generation method according to various embodiments.

At operation 310, the electronic device 100 may acquire a plurality of radiological images of a sample (e.g., the sample 210) moving on a transport device.

The radiation irradiation device 140 may emit radiation to the sample 210 that is moving, and the detector 150 may detect a radiation signal, accumulate the detected radiation signal for each set frame, and transmit an image signal to the processor 110, the memory 120, or the like. Using the image signal, the electronic device 100 may acquire the plurality of radiological images of the sample 210 at different positions as the sample 210 moves.

At operation 320, the electronic device 100 may determine feature points of the plurality of radiological images for reconstructing a 3D image of the sample 210.

For example, the electronic device 100 may determine a feature point of each of the plurality of radiological images, using the shape of the sample 210 or a marker. The electronic device 100 may analyze the radiological images, and determine the feature point of each of the plurality of radiological images based on a feature of the sample 210 captured in the radiological images. The feature point determined for each of the plurality of radiological images may correspond to the same portion of the sample 210.

At operation 330, the electronic device 100 may calculate position information of the feature points using positions of the feature points.

The electronic device 100 may calculate position information of a feature point of a radiological image and/or position information of a feature point of the sample 210, as expressed in Equations 1 to 4 above. The feature point of the sample 210 may represent a portion corresponding to the feature point of the radiological image.

At operation 340, the electronic device 100 may generate a feature point image based on the position information. For example, the electronic device 100 may generate the feature point image by matching the feature points of the respective radiological images based on the position information.

The feature point image may represent a 2D image for generating the 3D image of the sample 210. The electronic device 100 may synthesize some of the plurality of radiological images to generate the feature point image. The electronic device 100 may generate a plurality of feature point images.

At operation 350, the electronic device 100 may generate the 3D image using the feature point image and the position information. The electronic device 100 may synthesize the plurality of feature point images to generate the 3D image of the sample 210.

At operation 360, the electronic device 100 may determine whether the sample 210 is defective by comparing the 3D image to a set reference. The electronic device 100 may reduce the inspection time for the sample 210 by determining whether the sample 210 is defective, using the 3D image of the sample 210 generated using the plurality of radiological images.

FIG. 4 is a diagram illustrating an operation performed by the electronic device 100 to determine feature points using a plurality of radiological images according to various embodiments.

On determining a feature point of a radiological image, the electronic device 100 may determine a feature point of a radiological image of a subsequent frame based on the determined feature point of the radiological image. For example, the electronic device 100 may calculate a movement velocity of the feature point in the radiological image based on a movement velocity of the sample 210. Based on the movement velocity of the feature point of the radiological image, the electronic device 100 may determine a feature point of a radiological image captured in a frame subsequent to the radiological image in which the feature point is determined.

Further, the electronic device 100 may preprocess the radiological image based on the determined feature point of the radiological image. For example, the electronic device 100 may generate a preprocessed radiological image by cropping a set region based on the feature point of the radiological image.

The electronic device 100 may preprocess the radiological image of the frame subsequent to the radiological image in which the feature point is determined. For example, the electronic device 100 may preprocess the radiological image of the frame subsequent to the radiological image in which the feature point is determined, based on the movement velocity of the feature point of the radiological image.

When a feature point is recognized in a captured radiological image, the electronic device 100 may generate a feature point image, using the radiological image in which the feature point is recognized and a set number of radiological images captured from a point in time at which the radiological image in which the feature point is recognized is captured.

Radiological images shown in FIG. 4 may be arranged from left to right according to the order in which they are captured. That is, FIG. 4 illustrates an arrangement in which a plurality of radiological images captured in each frame is arranged sequentially.

For example, as shown in FIG. 4, in a case where a feature point of sample 1 is recognized in radiological image 1 410 and the set number is 17, the electronic device 100 may generate a feature point image of the sample 1 using radiological images from the radiological image 1 410 to radiological image 3 430.

For example, as shown in FIG. 4, in a case where a feature point of sample 2 is recognized in radiological image 2 420 and the set number is 17, the electronic device 100 may generate a feature point image of the sample 2 using radiological images from the radiological image 2 420 to radiological image 4 440.

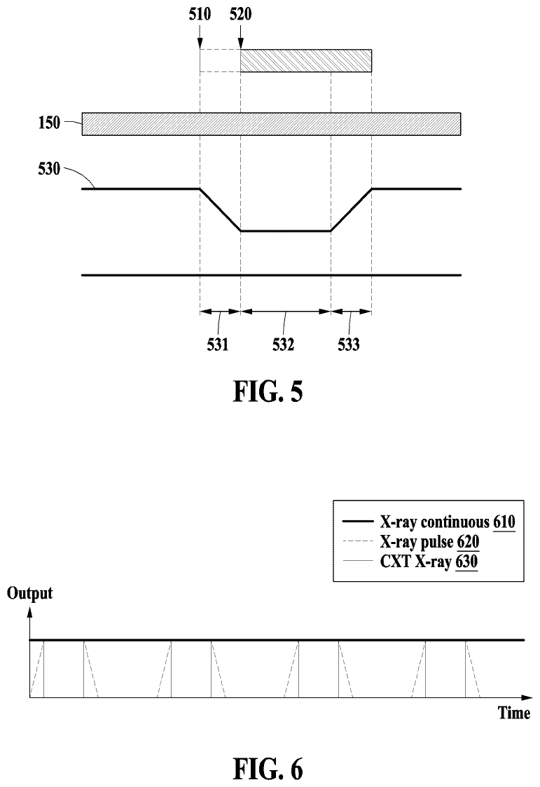

FIG. 5 is a diagram illustrating an image signal detected by the detector 150 as the sample 210 moves.

As shown in FIG. 5, the sample 210 may move from a first position 510 to a second position 520 over time. Assuming that radiation emitted from the radiation irradiation device 140 is incident perpendicularly to the detector 150, an entire image signal 530 may have a linearly decreasing image signal interval 531, a constant image signal interval 532, and a linearly increasing image signal interval 533, as the sample 210 moves.

An image signal detected by the detector 150 may represent the intensity or magnitude of radiation detected as being accumulated over each frame (or cycle of motion). The intensity or magnitude of the radiation detected in the interval 532 may be constant regardless of the movement of the sample 210, but the intensity or magnitude of the radiation detected in the intervals 531 and 533 may change with the movement of sample 210.

As shown in FIG. 5, in a case of capturing radiological images while the sample 210 is moving, there may be an afterimage on a radiological image due to an interval (e.g., the intervals 531 and 533) in which a detected radiation signal changes due to the movement of the sample 210, which may degrade the definition of the radiological image.

A clear radiological image may be necessary for the electronic device 100 to determine whether the sample 210 is defective using a 3D image of the sample 210. In a case of capturing radiological images of the sample 210 on the move, a moving artefact may occur. To acquire a clear radiological image in a case where the sample 210 is required to move at a high speed, the radiological images may need to be captured at a high speed such that a distance by which the sample 210 moves between frames is shortened.

By reducing a time for which image signals are accumulated, the definition of the radiological images captured for the sample 210 on the move may be improved or enhanced. A method of enhancing the definition of a radiological image will be described below with reference to FIGS. 6 and 7, according to embodiments.

FIG. 6 is a diagram illustrating an output of radiation emitted from the radiation irradiation device 140 according to various embodiments.

Referring to FIG. 6, the radiation irradiation device 140 of various embodiments may emit radiation in the form of a pulse to the sample 210. By emitting the radiation in the form of a pulse to the sample 210, the radiation irradiation device 140 may reduce a time for which image signals are accumulated and enhance the definition of captured radiological images.

As shown in FIG. 6, in a case where the radiation irradiation device 140 emits radiation (e.g., X-ray) continuously as shown in an output 610, a constant magnitude of radiation may be output regardless of time. In a case where the radiation irradiation device 140 emits radiation as shown in an output 620, an interval in which an output of the radiation increases and decreases for a short period of time and an interval in which radiation of a set magnitude is output may be repeated. In a case where the radiation irradiation device 140 emits radiation as shown in an output 630, the radiation may be output in the form of a pulse. The output 620 may be viewed as an output of radiation in the form of a pulse, but the output 620 may include some intervals where an output of the radiation increases or decreases linearly.

As shown in FIG. 6, in a case where the radiation irradiation device 140 emits radiation as shown in the output 630, a time for which the detector 150 accumulates image signals may be reduced compared to a case where the radiation is emitted as shown in the output 610 or the output 620. The radiation irradiation device 140 may emit radiation, as shown in the output 630, to enhance the definition of a radiological image.

For example, the radiation irradiation device 140 may include a carbon nanotube X-ray tube (CNT X-ray tube) and may digitally output radiation as shown in the output 630.

FIG. 7 is a diagram illustrating an operational frame of the detector 150 according to various embodiments.

As shown in FIG. 7, the detector 150 may detect an image signal by accumulating radiation signals (e.g., X-rays) over a window time 710 of the detector 150 corresponding to each frame. A window time described herein may be a reciprocal of a frame rate.

The electronic device 100 may increase the frame rate at which the image capture device 130 acquires radiological images, thereby increasing the number of images captured per second. Acquiring radiological images at a higher frame rate may reduce a time for which image signals are accumulated, and the electronic device 100 may thus acquire the radiological images of an improved or enhanced definition.

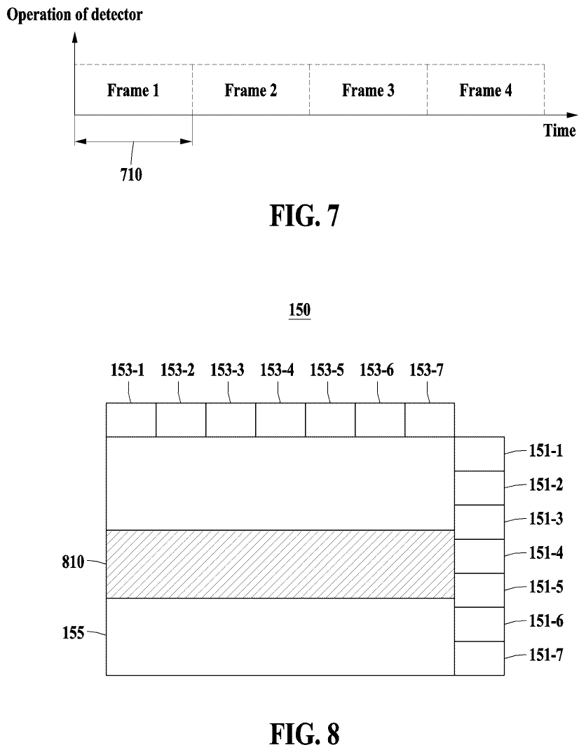

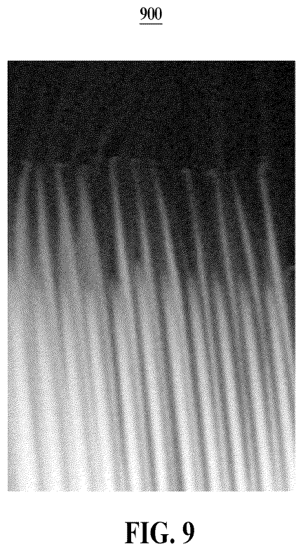

FIG. 8 is a diagram illustrating the gate line 151 and the output line 153 of the detector 150 according to various embodiments.

The detector 150 may include the gate line 151 and the output line 153 to transmit a signal (e.g., an image signal) detected on a panel 155. The electronic device 100 may drive the gate line 151 in an effective region corresponding to a region over which the sample 210 moves on a transport device to acquire a plurality of radiological images.

As shown in FIG. 8, a sample (e.g., the sample 210) may be moved by the transport device from left (e.g., a 9 o'clock direction in FIG. 8) to right (e.g., a 3 o'clock direction in FIG. 8) or from right to left. As shown in FIG. 8, a direction set for the sample 210 of one embodiment may be a direction from left to right or a direction from right to left.

The gate line 151 may be disposed in a direction parallel to the set direction in which the sample 210 moves. The gate line 151 may be disposed in the direction parallel to the set direction in which the sample 210 moves as shown in FIG. 8, which may facilitate controlling an output of signals detected from the panel 155 along the direction parallel to the set direction.

For example, as shown in FIG. 8, when a signal is applied to a gate line 151-1, a signal detected in a region of the panel 155 parallel to the set direction from the gate line 151-1 may be output according to a signal applied to a plurality of output lines 153-1, 153-2, 153-3, 153-4, 153-5, 153-6, and 153-7.

For example, when a signal is applied to the gate line 151-1 and the output line 153-1, a signal detected in a region where the region of the panel 155 horizontally parallel to the gate line 151-1 and a region of the panel 155 perpendicular to the output line 153-1 intersect may be output via the output line 153-1.

Referring to FIG. 8, the detector 150 may include a plurality of gate lines 151-1, 151-2, 151-3, 151-4, 151-5, 151-6, and 151-7, and a plurality of output lines 153-1, 153-2, 153-3, 153-4, 153-5, 153-6, and 153-7.

The panel 155 may accumulate radiation signals detected over a window time and store a signal (e.g., an image signal). To output the signal stored in the panel 155, the detector 150 may turn on a thin film transistor (TFT) of one line in a gate integrated circuit (IC) of the gate line 151, and then a signal of that line may be transmitted to a readout IC (ROIC) of the output line 153. The detector 150 may output the signal transmitted to the ROIC of the output line 153 to the outside of the detector 150.

For example, in a case where the detector 150 drives the gate line 151-1, a signal stored on a line in the panel 155 corresponding to the gate line 151-1 may be transmitted to the plurality of output lines 153-1, 153-2, 153-3, 153-4, 153-5, 153-6, and 153-7. The detector 150 may transmit the signal transmitted to the plurality of output lines 153-1, 153-2, 153-3, 153-4, 153-5, 153-6, and 153-7 to a component (e.g., the processor 110, the memory 120, etc.) of the electronic device 100 or to an external device.

A time used to output a signal from the output line 153 to the outside (e.g., the processor 110, the memory 120, etc.) of the detector 150 may be referred to as a line readout time, and a time for driving one frame may be acquired by multiplying the line readout time by the number of gate lines 151. Since the frame rate is a reciprocal of the time for driving a frame, the time for driving a frame may need to be reduced to increase the frame rate.

The electronic device 100 may reduce the number of gate lines 151 to increase the frame rate. As the frame rate is increased, a time for which image signals are accumulated may be reduced, which may enhance the definition of radiological images.

The effective region may refer to a region in which the sample 210 moves on the transport device. The electronic device 100 may drive the gate line 151 in the effective region to reduce the number of gate lines 151 to be driven. For example, as shown in FIG. 8, the electronic device 100 may drive the gate line 151-3, the gate line 151-4, and the gate line 151-5 corresponding to an effective region 810 to control a frame from which a plurality of radiological images is to be acquired. As shown in FIG. 8, of the plurality of gate lines 151-1, 151-2, 151-3, 151-4, 151-5, 151-6, and 151-7, the electronic device 100 may drive only the gate line 151-3, the gate line 151-4, and the gate line 151-5 corresponding to the effective region 810 to control the frame and increase the frame rate.

Although an example where a plurality of gate lines (e.g., 151-1, 151-2, 151-3, 151-4, 151-5, 151-6, and 151-7) is disposed parallel to a direction in which the sample 210 moves, and the electronic device 100 controls the driving of the plurality of gate lines 151-1, 151-2, 151-3, 151-4, 151-5, 151-6, and 151-7 to control a frame from which a plurality of radiological images is to be acquired has been described with reference to FIG. 8, but examples are not limited thereto. For example, a plurality of output lines (e.g., 153-1, 153-2, 153-3, 153-4, 153-5, 153-6, and 153-7) may be disposed parallel to the direction in which the sample 210 moves, and the electronic device 100 may control the driving of the plurality of output lines 153-1, 153-2, 153-3, 153-4, 153-5, 153-6, and 153-7 to control a frame from which a plurality of radiological images is to be acquired.

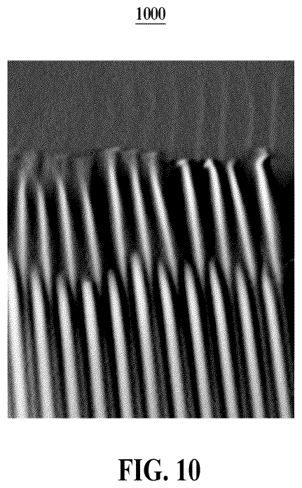

FIG. 9 is a 2D image 900 acquired by the electronic device 100 according to various embodiments. FIG. 10 is a cross-section 1000 of a 3D image generated by the electronic device 100 according to various embodiments.

The electronic device 100 may capture a radiological image 900 as shown in FIG. 9. Using a 3D image of a sample (e.g., the sample 210), the electronic device 100 may also determine a cross-section of the sample 210, as shown in FIG. 10.

For example, the electronic device 100 may determine whether a foreign object has been introduced into the sample 210, using the 3D image of the sample 210.

The methods described herein according to various embodiments may be written in a computer-executable program and may be implemented by various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine-readable storage device (a computer-readable medium) to process the operations of a data processing device, for example, a programmable processor (e.g., the processor 110), a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors (e.g., the processor 110) suitable for processing a computer program include, by way of example, both general and special purpose microprocessors (e.g., the processor 110), and any one or more processors (e.g., the processor 110) of any kind of digital computer. Generally, a processor (e.g., the processor 110) may receive instructions and data from a read-only memory (e.g., the memory 120) or a random-access memory (e.g., the memory 120), or both. Elements of a computer may include at least one processor for executing instructions and one or more memory devices for storing instructions and data. Generally, a computer may also include, or be operatively coupled, to receive data from or transfer data to, or both, one or more mass storage devices for storing data, e.g., magnetic disks, magneto-optical disks, or optical discs. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor (e.g., the processor 110) and the memory (e.g., the memory 120) may be supplemented by, or incorporated in, special-purpose logic circuitry.

In addition, non-transitory computer-readable media may be any available media that may be accessed by a computer and may include both computer storage media and transmission media.

Although the present disclosure includes details of a plurality of specific example embodiments, the details should not be construed as limiting any invention or a scope that can be claimed, but rather should be construed as being descriptions of features that may be unique to specific example embodiments of specific inventions. Specific features described in the present disclosure in the context of individual example embodiments may be combined and implemented in a single example embodiment. On the contrary, various features described in the context of a single example embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or that all the shown operations must be performed in order to acquire a preferred result. In some specific cases, multitasking and parallel processing may be advantageous. In addition, it should not be understood that the separation of various device components of the aforementioned example embodiments is required for all the example embodiments, and it should be understood that the aforementioned program components and devices may be integrated into a single software product or packaged into multiple software products.

The example embodiments described in the present disclosure and the drawings are intended merely to present specific examples in order to aid in understanding of the present disclosure but are not intended to limit the scope of the present disclosure. It will be apparent to a person of ordinary skill in the art that various modifications based on the technical spirit of the present disclosure, as well as the disclosed example embodiments, can be made.

1. An electronic device, comprising:
an image capture device configured to acquire a plurality of radiological images of a sample moving in a set direction on a transport device; and
a processor,
wherein the processor is configured to:
determine a feature point of the plurality of radiological images for reconstructing a three-dimensional (3D) image of the sample;
calculate position information of the feature point, using a position of the feature point;
generate a feature point image based on the position information; and
generate the 3D image using the feature point image and the position information.

2. The electronic device of claim 1, wherein the image capture device comprises a radiation irradiation device and a detector having two-dimensionally arranged pixels, and is configured to acquire the plurality of radiological images when the sample passes through a cone beam region determined according to the radiation irradiation device and the detector.

3. The electronic device of claim 2, wherein the radiation irradiation device is configured to:
emit radiation in the form of a pulse to the sample.

4. The electronic device of claim 2, wherein the detector comprises:
a gate line and an output line for transmitting a signal detected on a panel of the detector,
wherein the processor is configured to:
control a frame from which the plurality of radiological images is acquired by driving the gate line in an effective region corresponding to a region in which the sample moves on the transport device,
wherein the gate line is disposed in a direction parallel to the set direction in which the sample moves.

5. The electronic device of claim 1, wherein the processor is configured to:
determine whether the sample is defective by comparing the 3D image to a set reference.

6. The electronic device of claim 1, wherein the image capture device is configured to:
acquire a plurality of radiological images of a plurality of samples,
wherein the processor is configured to:
determine the feature point, using the plurality of radiological images of the plurality of samples.

7. The electronic device of claim 1, wherein the processor is configured to:
preprocess the plurality of radiological images; and
determine the feature point using the preprocessed plurality of radiological images.

8. The electronic device of claim 1, wherein the processor is configured to:
determine whether a foreign object has been introduced into the sample by comparing a pixel value of the plurality of radiological images to a set threshold value.

9. An electronic device, comprising:
an image capture device configured to acquire a plurality of radiological images of a sample moving in a set direction on a transport device; and
a processor,
wherein the processor is configured to:
determine a feature point of the plurality of radiological images, based on at least one of a shape of the sample and a feature of the plurality of radiological images;
calculate position information of the sample corresponding to the feature point, using a position of the feature point and a speed of the transport device; and
generate a three-dimensional (3D) image of the sample by matching the plurality of radiological images, based on the position information.

10. The electronic device of claim 9, wherein the image capture device comprises a radiation irradiation device and a detector having two-dimensionally arranged pixels, and is configured to acquire the plurality of images when the sample passes through a cone beam region determined according to the radiation irradiation device and the detector.

12. The electronic device of claim 9, wherein the processor is configured to:
determine whether the sample is defective by comparing the 3D image to a set reference.

12. A three-dimensional (3D) image generation method, comprising:
acquiring, using an image capture device, a plurality of radiological images of a sample moving in a set direction on a transport device;
determining a feature point of the plurality of radiological images for reconstructing a 3D image of the sample;
calculating position information of the feature point using a position of the feature point;
generating a feature point image based on the position information; and
generating the 3D image, using the feature point image and the position information.

13. The 3D image generation method of claim 12, wherein the image capture device comprises:
a radiation irradiation device and a detector having two-dimensionally arranged pixels,
wherein the acquiring of the plurality of radiological images comprises:
acquiring the plurality of radiological images when the sample passes through a cone beam region determined according to the radiation irradiation device and the detector.

14. The 3D image generation method of claim 13, wherein the acquiring of the plurality of radiological images comprises:
emitting radiation in the form of a pulse to the sample, using the radiation irradiation device.

15. The 3D image generation method of claim 13, wherein the detector comprises:
a gate line and an output line for transmitting a signal detected on a panel of the detector,
wherein the acquiring of the plurality of radiological images comprises:
controlling a frame from which the plurality of radiological images is acquired, by driving the gate line in an effective region corresponding to a region in which the sample moves on the transport device,
wherein the gate line is disposed in a direction parallel to the set direction in which the sample moves.

16. The 3D image generation method of claim 12, further comprising:
determining whether the sample is defective by comparing the 3D image to a set reference.

17. The 3D image generation method of claim 12, wherein the acquiring of the plurality of radiological images comprises:
acquiring a plurality of radiological images of a plurality of samples,
wherein the determining of the feature point comprises:
determining the feature point, using the plurality of radiological images of the plurality of samples.

18. The 3D image generation method of claim 12, further comprising:
preprocessing the plurality of radiological images,
wherein the determining of the feature point comprises:
determining the feature point, using the preprocessed plurality of radiological images.

19. The 3D image generation method of claim 12, further comprising:
determining whether a foreign object has been introduced into the sample by comparing a pixel value of the plurality of radiological images to a set threshold value.
